(19) United States
(12) Patent Application Publication
(10) Pub. No.: US 2006/0136978 A1
(43) Pub. Date: Jun. 22, 2006

(54) Extendable interface and method for digital television

(76) Inventors: Yan-Lang Chou, Hsinchu (TW); Juin-Ming Tsai, Hsinchu (TW)

Correspondence Address: RABIN & BERDO, P.C., Suite 500, 1101 14 Street, N.W., Washington, DC, 20005, US

(21) Appl. No.: 11/080,516

(22) Filed: Mar. 16, 2005

(30) Foreign Application Priority Data
Dec. 22, 2004 (TW) 93140072

(51) Int. Cl. H04N 7/173; H04N 7/16; G06F 17/00; G06F 19/00; A63F 9/24; A63F 13/00

(52) U.S. Cl. 725/133; 725/135; 725/141; 463/40

(57) ABSTRACT

An extendable interface and method for digital televisions are disclosed. According to the pre-defined specifications of the interface, any extendable peripheral is appended to a back end of the digital television conveniently for extension. The extendable peripheral may comprise: a front end of the digital television, a network service module, a storage memory module and others compliant with the pre-defined specifications of the interface.

### BACKGROUND OF THE INVENTION

1. Field of Invention

The invention relates to an extendable interface and method and, in particular, to an extendable interface and method for digital televisions.

2. Related Art

Mass transmission of digital data is the most important thing in future knowledge economics. In particular, the rapid development and growth in software and hardware industries pushed by the digital television (TV) have brought enormous economical benefits to the countries all over the world. Thus, this area of industry has received much attention in these years.

As shown in FIG. 1, a conventional digital TV can be divided into the following parts: a back end 100, a front end 110, a network service module 120, and a storage memory module 130. The back end 100 processes received digital data and has a form basically the same as a personal computer system, including a central processing unit (CPU) 101, a dynamic memory module 102, a conditional access module 103, an audio/video (AV) player module 104, an audio decoding module 105, and a video decoding module 106 to achieve the real-time playing, arbitrary recording/playing, conditional playing, and interactive services. The front end 110 provides the functions of signal demodulation and channel control, including a demodulation module 111 and a channel selection module 112. The network service module 120 is a basic module that enables the digital TV to have an interactive service mechanism. The storage memory module 130 stores the software required by the digital TV so that it can keep data even when the digital TV is turned off.

The above-mentioned basic structure of the digital TV may be added with additional features according to the user's needs or provided services. However, these digital TV structures usually are not extendable and flexible. Therefore, if the user has new needs or the provided services change, the only choice is to purchase a new one. This is not only a big financial burden for the users, the development of digital TV's is also restricted.

For example, the existing digital TV's have many different systems, each of which has a distinct modulation method. In addition to the rough classifications of the European standard, the American standard, and the IPTV standard, the European standard and the American standard are further divided into surface broadcasting, wired broadcasting, and satellite broadcasting. If the user purchases a digital TV of the European standard with the surface broadcasting, it is impossible to switch to the American standard with the wired broadcasting without purchasing a new digital TV. It is very impractical. The same situation also happens when the user want to add new interactive services to the digital TV. For example, if the user wants to switch from the ADSL service to the cable modem service, a new digital TV is required due to the different network services provided by the providers or the different linking networks. When the hardware structure of a digital TV is changed, the require software has to be changed too in order for the TV to work properly. This situation can be seen from the difference between FIGS. 2A and 2B. When the digital TV is equipped with network services, the software that has to be stored in the storage memory module 130 includes: the real-time operating system (OS) 131, the middleware 132, and various kinds of applications 133. On the other hand, if the digital TV is not equipped with network services, the storage memory module 130 only needs to hold the real-time OS 131 and playing software 134.

All these problems show that the conventional digital TV structure is in lack of flexibility and convenience in extensions. As a result, users are more hesitant to select and purchase. This definitely will affect the future development of the digital TV industry. If one wants to fully solve the existing problems in the digital TV structure, it is imperative to provide a method for improving its extendibility. This is believed to greatly increase user's will to purchase the products.

Although a digital TV with an extendable system card has been proposed in the R.O.C. Pat. No. 541,836, it is mainly to provide an interface for conditional access on the digital TV. The digital TV can therefore execute applications on this interface to achieve the control of conditional access. In the U.S. Pat. No. 6,101,368, an interface for bidirectional communications between an external device and the digital TV is proposed so that the external device can control and access the digital TV. Each of these prior arts provides an interface that can be combined with the digital TV. However, they are restricted to the extension of a specific function of the digital TV, instead of a universal extendable interface. Consequently, their effects in solve the existing problem in digital TV's are very limited. We are still in need of an extendable interface for the digital TV.

### SUMMARY OF THE INVENTION

In view of the foregoing, an objective of the invention is to provide a consistent extendable interface and method for digital TV's. In particular, the front end, the network service module and the storage memory module are provided for the user to have a convenient extendable interface. Any other extendable peripheral compliant with the defined extension interface standard can be extended using the disclosed extendable interface.

The disclosed extendable interface for the digital TV includes: a power supply port, a control signal port, a serial bus, a parallel bus, and a signal transport port.

The disclosed method of extending the digital TV includes the steps of: connecting an extendable peripheral to the back end of the digital TV; providing a power supply port for the back end to provide power to the extendable peripheral; providing a control signal port for the back end to control, set, and identify the extendable peripheral; providing a serial bus for the back end to initialize settings and access bi-directional data on the extendable peripheral; providing a parallel port for the back end to perform bi-directional data access with the extendable peripheral; and providing a signal transport port for the back end to receive signals from the extendable peripheral.

The required methods for implementing communications between each extendable peripheral and the back end of a digital TV may not be completely the same. In addition to the power supply of the power supply port and the control, setting, and identification provided by the control signal port, the operations of the serial bus, the parallel bus, and the signal transport port can be selectively chosen to form links with the back end according to one's needs.

Using the invention, the user can use a consistent interface to extend the applications of the digital TV. Moreover, one interface can support the extension of more than one function. This can increase the convenience of the digital TV and the development of the industry.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the conventional digital TV structure;

FIG. 2A is a schematic view of the software contents stored in the storage memory module when the digital TV is equipped with network services;

FIG. 2B is a schematic view of the software contents stored in the storage memory module when the digital TV is not equipped with network services;

FIG. 3 is a schematic view of the digital TV structure with the disclosed extendable interface; and

FIG. 4 is a flowchart of the disclosed extension method of extendable interface for the digital TV.

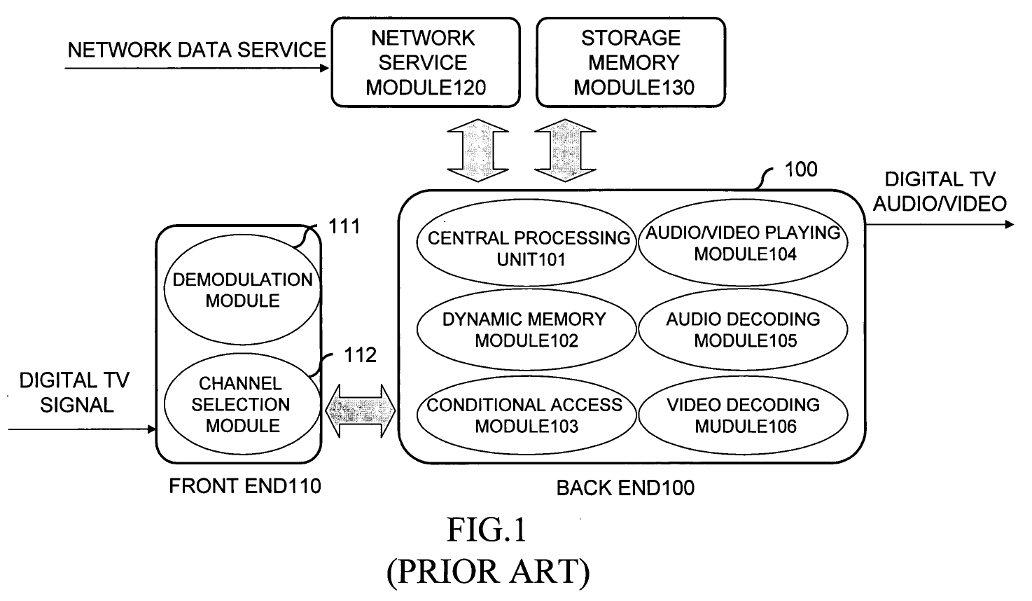

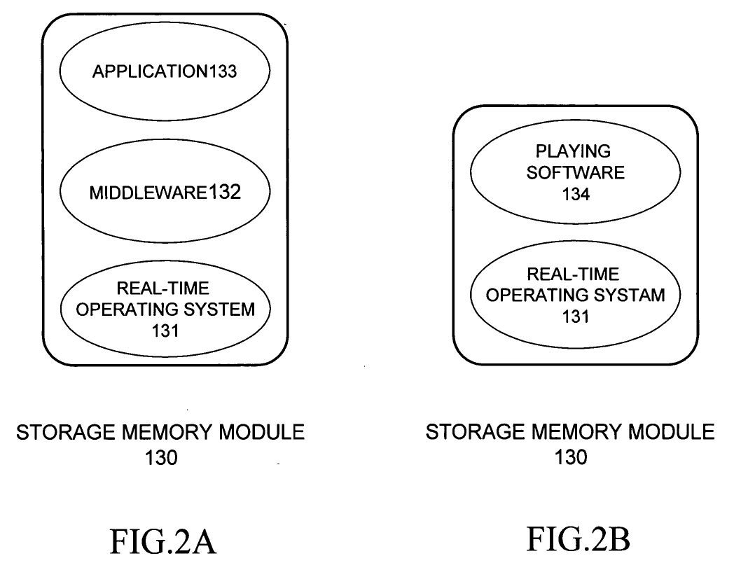

### DETAILED DESCRIPTION OF THE INVENTION

The disclosed extendable interface 200 for the digital TV mainly provide a link between the back end of the digital TV and a connected extendable peripheral, such as the front end 110, the network service module 120, and the storage memory module 130. This facilitates various extensions of the digital TV. Its general structure includes the following elements:

(1) A power supply port 210 is used to provide power from the back end 100 to the connected extendable peripheral. The supplied power is mainly the well-known 30V, 12V, 5V, 3.3V and the ground GND.

(2) A control signal port 220 is used to provide the back end 100 controls, settings, and identification of the extendable peripheral. The common control signals include: the control signal of executing the control signals for the extendable peripheral, restart, or reset; the interrupt signal of controlling the central processing unit (CPU) 101 to execute a routine interrupt and a new request; the identification signal of providing the back end 100 of the digital TV as a means to identify the extendable peripheral.

(3) A serial bus 230 is used to enable the back end 100 to initialize the settings and perform bi-directional data access on the extendable peripheral. For example, the channel selection module 112 in the front end 110 is initialized by the back end 100 through this serial bus. A general serial bus 230 is an Inter 1C (1²C) bus or a serial peripheral interface (SPI) bus.

(4) A parallel bus 240 is used to allow the bidirectional data access between the back end 100 and the extendable peripheral. The signal types commonly used in the parallel bus 240 include: the address bus signal, the data bus signal, the read/write (R/W) signal, the OE signal, the ready signal, the chip select signal, and the write enable byte 0 signal.

(5) A signal transport port 250 is used to enable the back end 100 to receive signals transmitted from the extendable peripheral. For example, the front end 110 transmits the signal transport flow demodulated by a demodulation module 111 via this signal transport port to the back end 100. The signals in the signal transport flow include: the clock synchronization signal CLK, the packet synchronization signal SYNC, the packet signal Valid, the data signal Data, and the error signal Error.

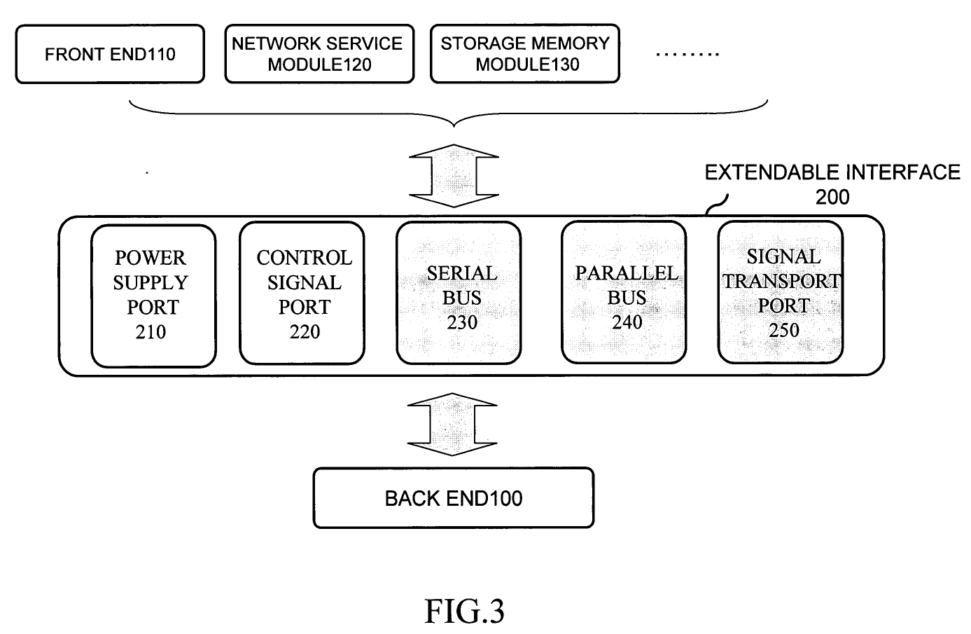

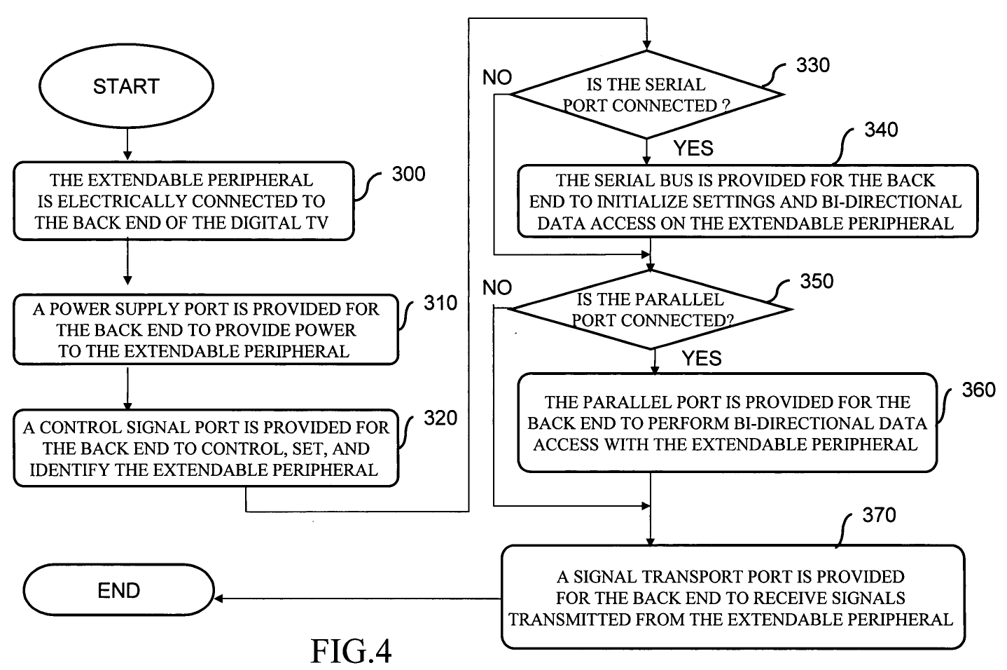

Using the above structure, the combination of the disclosed extendable interface 200 and the digital TV, as illustrated in FIG. 3, allows the extensions of the front end 110, the network service module 120, the storage memory module 130, or any other extendable peripheral according to the different needs. The extension method is further described using FIG. 4.

First, the extendable peripheral is electrically connected to the back end 100 of the digital TV (step 300). A power supply port 210 is then provided for the back end 100 to provide power to the extendable peripheral (step 310). A control signal port 220 is provided for the back end 100 to control, set, and identify the extendable peripheral (step 320). Basically, all the extendable peripherals have to be power supplied and monitored by the back end 100. Therefore, steps 310 and 320 are mandatory.

Other steps depend on the type of the extendable peripheral and are executed selectively. First, the system checks whether the extendable peripheral is already connected to the serial bus 230 (step 330). If so, then the serial bus 230 is provided for the back end 100 to initialize settings and bi-directional data access on the extendable peripheral (step 340). Otherwise, the system directly checks whether the extendable peripheral has connected to the parallel port 240 (step 350). If so, the parallel port 240 is provided for the back end 100 to perform bi-directional data access with the extendable peripheral (step 360). Otherwise, the system directly provides a signal transport port 250 for the back end 100 to receive signals transmitted from the extendable peripheral (step 370).

It is thus seen that aside from steps 310 and 320, other steps in the disclosed method may or may not be necessary for different kinds of extendable peripherals connected to the extendable interface 200 for the digital TV.

For example, suppose the extendable peripheral is the front end 110 of the digital TV. Since channel selection information needs to be exchanged between the back end 100 and the front end 110, step 340 has to be performed. Moreover, the front end 110 has to demodulate the received digital TV signal into a signal transport flow before sending it to the back end 100. Therefore, step 370 has to be executed too. Step 360, on the other hand, is not necessary. The user can thus change the standard and transmission method of the digital TV system by extending its front end 110.

Suppose the extendable peripheral enables bi-directional interactive services, such as a network service module 120 that provides video-telephone, online games, stock transactions, online shopping, information services, etc, the serial bus 230 has to be provided. That is, step 340 has to be executed for the back end 100 to perform bi-directional data access with the network services provided by the network service module 120. The user can freely select the required network connection type when extending its network service module 120, e.g. ADSL, Ethernet, cable modem, PSTN, GPRS, etc.

Suppose the extendable peripheral to be connected is a storage memory module 130 for storing the software program required by the back end 100, then step 360 is mandatory to provide the parallel port as a channel for the storage memory module 130 and the back end 100 to exchange data. The user can update the software contents, including the real-time OS 131, the middleware, various applications, and the playing software, in the storage memory module 130 at any time.

Basically, all the extendable peripherals can communicate with the back end 100 of the digital TV through the procedure described above. In addition to the front end 110, the network service module 120, and the storage memory module 130 mentioned before, any other extendable peripheral compliant with the standard defined in the disclosed extendable interface 200 for the digital TV can be implemented according to the invention.

In fact, all the technical contents described before, including the extendable interface 200 and method for the digital TV, can be implemented on the so-called set top box. The operation mechanisms of the set top box and the digital TV are roughly the same. The only difference is that the digital TV has a display function while the set top box does not. Therefore, the implementation on the set top box is another embodiment of the invention.

Certain variations would be apparent to those skilled in the art, which variations are considered within the spirit and scope of the claimed invention.

What is claimed is:

1. An extendable interface for a digital television (TV) for providing a communication link between a back end of the digital TV and a plurality of connected extendable peripherals, the back end providing the digital TV and related digital services to a user and the extendable peripherals providing other extended digital services to the user, the extendable interface including:
a serial bus, which enables the back end to initialize settings and perform bi-directional data access on the extendable peripherals;
a parallel bus, which enables the bi-directional data access between the back end and the extendable peripherals;
a signal transport port, which allows the back end to receive signals transmitted from the extendable peripherals;
a control signal port, which allows the back end to control, set, and identify the extendable peripherals; and
a power supply port, which enables the back end to provide power to the extendable peripherals;
wherein the serial bus, the parallel port, and the signal transport port are selectively employed to connect different types of the extendable peripherals to the back end of the digital TV.

2. The extendable interface for a digital TV of claim 1, wherein the extendable peripheral is a front end connected to the back end via the serial bus, the signal transport port, the control signal port, and the power supply port for transmitting channel selection information made at the back end via the serial bus to the front end, the front end demodulating a received digital TV signal into a signal transport flow according to the channel selection information and sending it back to the back end via the signal transport port.

3. The extendable interface for a digital TV of claim 1, wherein the extendable peripheral is a network service module connected to the back end via the parallel bus, the control signal port, and the power supply port, realizing the bidirectional data access of the network services provided by the network service module.

4. The extendable interface for a digital TV of claim 1, wherein the extendable peripheral is a storage memory module that stores the software programs required by the back end and connects to the back end via the parallel port, the control signal port, and the power supply port, realizing bidirectional software program access with the back end.

5. The extendable interface for a digital TV of claim 1 applicable to a set top box.

6. An extension method for a digital television (TV) for providing a communication link between a back end of the digital TV and a plurality of connected extendable peripherals, the back end providing the digital TV and related digital services to a user and the extendable peripherals providing other extended digital services to the user, the extendable interface including:, which comprises the steps of:
providing the power supply port, which supplies power from the back end to the front end;
providing the control signal port for the back end to control, set, and identify the front end;
providing the serial bus for transmitting channel selection information made at the back end via the serial bus to the front end; and
providing the signal transport port so that after the front end demodulates a received digital TV signal according to the channel selection information into a signal transport flow, the signal transport flow is transmitted back to the back end via the signal transport port.

7. An extension method for the extendable interface for the digital TV of claim 6, which when the extendable peripheral is a network service module comprises the steps of:
providing the power supply port, which supplies power from the back end to the network service module;
providing the control signal port for the back end to control, set, and identify the network service module; and
providing the serial bus for bi-directional data access between the back end and the network services provided by the network service module.

8. The extension method for the extendable interface for the digital TV of claim 6, which when the extendable peripheral is a storage memory module comprises the steps of:
providing the power supply port, which supplies power from the back end to the storage memory module;
providing the control signal port for the back end to control, set, and identify the storage memory module; and
providing the parallel bus for bi-directional data access of software programs between the back end and the storage memory module.

9. The extension method for the extendable interface for the digital TV of claim 6 applied to a set top box.
